(19) United States
(12) Patent Application Publication
(10) Pub. No.: US 2009/0144701 A1
(43) Pub. Date: Jun. 4, 2009

(54) METHODS AND SYSTEMS FOR PROVIDING CONFIGURATION DATA

(76) Inventor: Norman Lee Faus, Holly Springs, NC (US)

Correspondence Address: MH2 TECHNOLOGY LAW GROUP (Cust. No. w/Red Hat), 1951 KIDWELL DRIVE, SUITE 550, TYSONS CORNER, VA, 22182, US

(21) Appl. No.: 11/948,623

(22) Filed: Nov. 30, 2007

(51) Int. Cl. G06F 9/44; G06F 15/16

(52) U.S. Cl. 717/121

(57) ABSTRACT

Systems and methods provide real time and interactive software configuration. A configuration support module is configured to provide configuration data associated with software being configured by a user. The configuration support module is configured to store configuration data associated with different entities related to users. The entities can be a company, organization, corporation, association, and the like related to the users. The configuration support module can store configuration data that is common to different users related to the entity.

### FIELD

This invention relates generally to products and services, more particularly, to systems and methods for providing support for products and services.

### DESCRIPTION OF THE RELATED ART

The proliferation of the World Wide Web through the Internet has made a wealth of products and services available to users to purchase and use nearly instantaneously. Vendors, service providers, manufacturers, third party distributors, etc., may have websites for the users to review and purchase their respective products and/or services and to obtain technical support for the product and/or services.

Although most computers come pre-configured with some computer software, most users must install and/or configure additional computer software on their computer to tailor their computer for their particular needs. Such computer software installation and/or configuration can be as easy as a one step activation of an installation program. Because of this complex nature, the post install configuration can not be automated without some level of user interaction or knowledge of the prexisting system. However, in order to make software truly operational, more complex computer applications require a user to perform post-installation configuration of the software.

Unfortunately, post-installation configuration can be difficult. Some post installation configuration decisions require knowledge of an installation parameter and/or a configuration parameter, e.g., parameters of a user's computer hardware, operating system parameters, other computer programs installed on the user's computer, etc. Without a user making the proper post-installation configuration, the installed software may either not execute at all or alternately may not execute in the manner desired.

Often, to properly install the software, the user may have to contact a support person. However, the user may have to wait in order to receive help from the support person. This may waiting may be unnecessary since the configuration of the software may be similar to previous configurations of the software. Thus, there is a need in the art for providing configuration data.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 depicts an exemplary system in accordance with an embodiment;

FIG. 2 illustrates an exemplary service portal of the system shown in FIG. 1 in accordance with another embodiment;

FIG. 3 depicts an exemplary CS module shown in FIG. 1 in accordance with yet another embodiment;

FIGS. 4A-4D illustrates an exemplary configuration interfaces in accordance with yet another embodiment;

FIG. 5 depicts an exemplary flow diagram in accordance with yet another embodiment;

FIG. 6 depicts another exemplary flow diagram in accordance with yet another embodiment; and

FIG. 7 depicts an exemplary computing platform in accordance with yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of information and service portals, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments relate generally to systems and methods for providing a real time and interactive software configuration. More particularly, a configuration support module is configured to provide configuration data associated with software being configured by a user. The configuration support module is configured to store configuration data associated with different entities related to users. The entities can be a company, organization, corporation, association, and the like related to the users. For example, the configuration support module can store configuration data that is common to different users related to the entity.

The configuration data can be settings and parameters in order to set-up and configure the software. The configuration data can be frequently used configuration data for the software, previously used configuration data for the software, configuration data specified by the entity, and the like.

The configuration support module can be configured to receive a request for configuration data. The configuration support module can receive the request from software being installed by a user. In response to the request, the configuration support module can be configured to generate an interface in order to receive identifying information for the user. The identifying information can include the entity related to the and the user's relationship to the entity. Based on the determined identifying information, the configuration support module can be configured to search for stored configuration data. The configuration support module can then be configured to retrieve the stored configuration data based on the identifying information.

The configuration support module can be configured to allow the user to store configuration data and to modify the stored configuration data. The configuration support module can be configured to allow the user to modify the configuration data based on the identity of the user. For example, the user can be an administrator of the entity and the configuration support module can allow the user to modify the configuration data based on the user identity as an administrator.

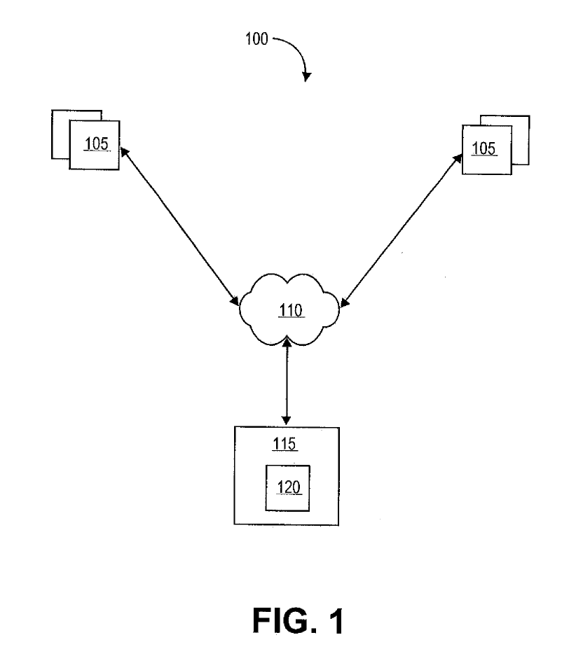

FIG. 1 illustrates an exemplary system 100 in accordance with an embodiment. It should be readily apparent to those of ordinary skill in the art that system 100 depicted in FIG. 1 represents a generalized schematic illustration and that other components may be added or existing components may be removed or modified. Moreover, system 100 may be implemented using software components, hardware components, or combinations thereof.

As shown in FIG. 1, system 100 includes users 105, a network 110 and a web service portal 115. Users 105 can be private individuals, employees of private business or public entities or other persons interested in accessing web service portal 115. Users 105 can access web service portal 115 using personal computers, personal mobile devices, workstations or other networked computing platforms.

Network 110 can be a combination of wide area and local area networks such as the Internet. Network 110 can be configured to provide a communication channel between users 105 and web service portal 115. Network 110 can implement a variety of network protocols to provide the communication channel such as Internet Protocol (“IP”) Vx, ATM, SONET, or other similar network protocols.

Web service portal 115 can be configured to provide products and services to user 105 as well as provisioning, installation services, updates to software and hardware products and technical support. Web service portal 115 can, among other functions, provide a list of products such as software applications and/or hardware devices as well as services such as installation, configuration, maintenance, etc., for users 105 to purchase. As a non-limiting example, web service portal 115 can also provide information for users to research, compare and purchase software, hardware and consulting services in support of those software and/or hardware purchases. Web service portal 115 can also be configured to provide support services, for free or by subscription, to those same software, service, and/or hardware purchases.

In accordance with various embodiments, web service portal 115 can be configured to provide a configuration support (CS) module 120 to provide support in configuring software acquired from web service portal 115. CS module 120 can be configured to provide configuration data associated with software that can be acquired from web service portal 115. CS module 120 can be configured to store configuration data associated with different entities related to users 105. The entities can be a company, organization, corporation, association, and the like related to users 105. For example, CS module 120 can store configuration data that is common to different users related to the entity.

The configuration data can be at least settings and parameters in order to set-up and configure the software. The configuration data can be frequently used configuration data for the software, previously used configuration data for the software, configuration data specified by the entity, and the like.

CS module 120 can be configured to receive a request for configuration data. CS module 120 can receive the request from software being installed by user 105. In response to the request, CS module 120 can be configured to determine identifying information for user 105. The identifying information can include the entity related to user 105 and user 105 relationship to the entity. Based on the determined identifying information, CS module 120 can be configured to search for stored configuration data. CS module 120 can be configured to retrieve the stored configuration data based on the identifying information.

CS module 120 can be configured to allow user 105 to store configuration data and to modify the stored configuration data. CS module 120 can be configured to allow the user to modify the configuration data based on the identity of the user. For example, user 105 can be an administrator of the entity and CS module 120 can allow the user to modify the configuration data based on the user identity as an administrator.

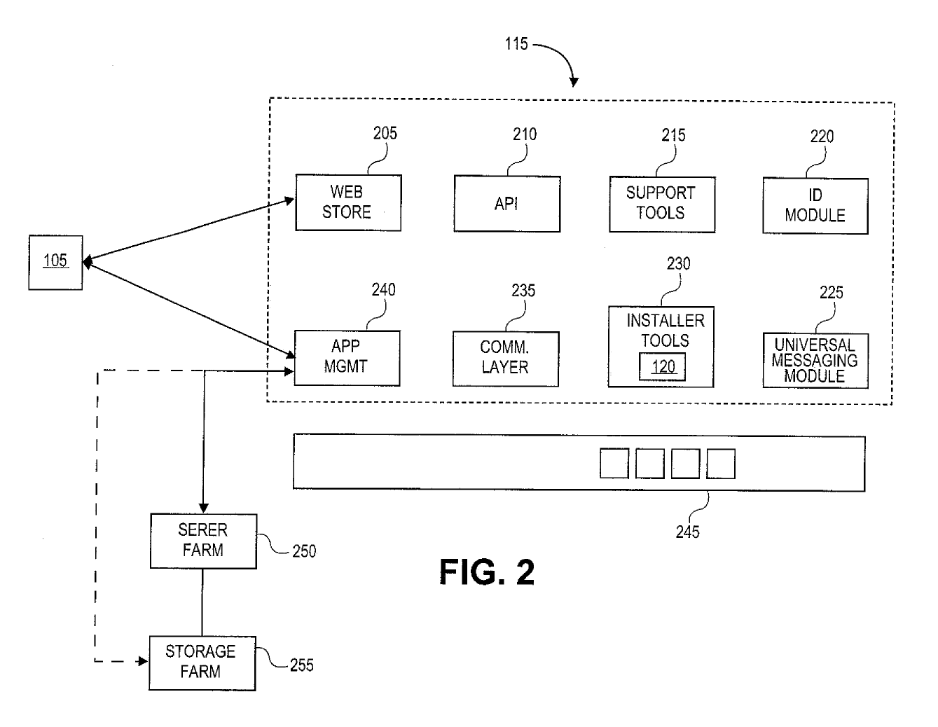

FIG. 2 illustrates a more detailed block diagram of web service portal 115 in accordance with another embodiment. It should be readily apparent to those of ordinary skill in the art that web service portal 115 depicted in FIG. 2 represents a generalized schematic illustration and that other components may be added or existing components may be removed or modified.

As shown in FIG. 2, web service portal 115 can include a web store module 205 that a user can interface with the service portal. Web store module 205 can provide the graphical user interfaces (“GUIs”) and associated functions and/or services for web service portal 115. As a non-limiting example, web store module 205 can generate a log-in GUI for a user to authenticate and enter web service portal 115.

Web store module 205 can couple with an application program interface (“API”) module 210. API module 210 can be configured to provide an interface between the functions and/or services provided by web store module 205 and to the appropriate module of web service portal 115. More particularly, API module 210 can call or direct a requested function or service from the user to the respective module that provides that requested function or service. For example, a user may request a price of a product, e.g., product vending module, APT module 210 can direct the request to a get price function in a support tools module 215.

API module 210 can also be configured to interface with support tools module 215. Support tools module 215 can be configured to provide the supporting software and hardware to implement the functionality of web service portal 115. Support tools module 215 can contain and provide access to databases that contain information such as products lines, services providers, on-line self-help (e.g., knowledgebase), etc. Support tools module 215 can also provide services like a chat services, a help desk, installation, provisioning, etc.

API module 210 can be further configured to couple with an identification (“ID)”) module 220. ID module 220 can be configured to provide identification management services for web service portal 115. ID module 220 can also store information related to users such as purchase history, user profile, usage history of the user, and entitlement data.

API module 210 can be further configured to couple with a universal messaging module 225. Universal messaging module 225 can be configured to provide a messaging application that unifies messages. More specifically, electronic mail (“email”), documents, and instant messaging can be linked in a single application. Universal messaging module 225 can also provide a mechanism for a user to view all the related documents for the user from email to Wiki pages.

An installer tools 230 can be coupled to API module 210. One of the services provided by web service portal 115 can be the purchase of software applications provided by independent software vendors (“ISVs”). As part of the delivery of the software applications, the ISV can be required to maintain and update the installation tools to install their respective software applications. Accordingly, installer tools 230 can be a repository where independent software vendors can deposit their respective installation tools.

API module 210 can be further coupled to a communication layer 235 (labeled as COMM layer in FIG. 2). Communication layer 235 can be configured to provide the underlying services for the modules of web service portal 115 to communicate. For example, communication layer 235 can contain middleware for a product database to communicate with a graphical user interface requesting product description.

API module 210 can be further coupled to an application management module 240 (labeled as APP MGMT in FIG. 2). Application management module 240 can be configured to manage applications as requested by users. More specifically, a user may purchase a prepackaged software application pack (e.g., an operating system, electronic mail program and data mining program) from web service portal 115, which is stored in an application stack module 245. Application management module 240 can then deliver the purchased software stack, install and configure the software application stack at a third party site such as server farm 250 or store the software application stack in a storage farm 255 for the user to retrieve.

Server farm 250 can be configured to provide computing platforms for users to lease. Accordingly, users can have a backup version of their systems, a testing platform to perform quality assurance tests on new applications, execute a program requiring excessive MIPS, or any other similar computing task.

Storage farm 255 can be configured to provide storage space for users to lease. Accordingly, users can lease disk storage space to back up data, provide a hot data swap, or other storage intensive tasks.

In some embodiments, CS module 120 can be configured to be executed in installer tools 230. In other embodiments, CS module 120 can be executed as a standalone module.

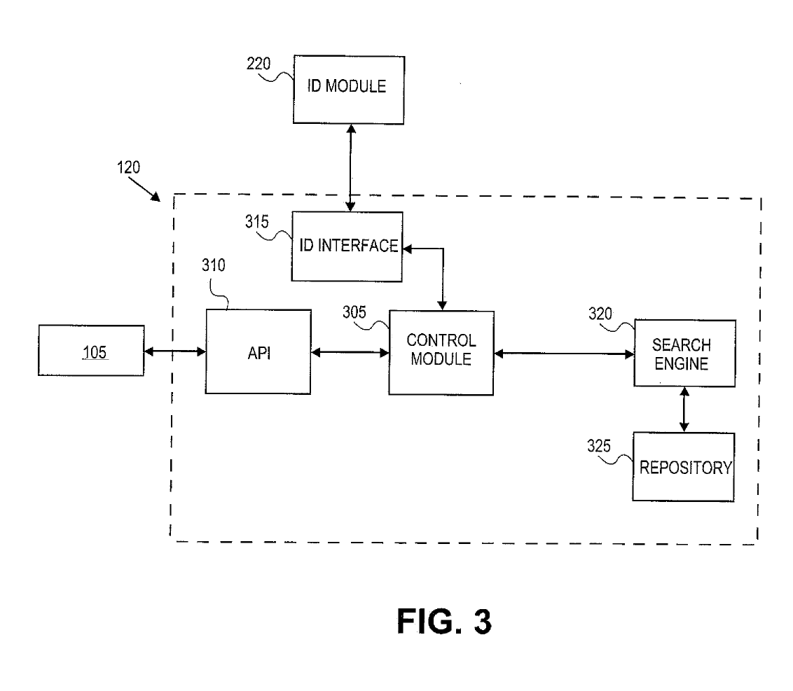

FIG. 3 depicts a more detailed block diagram of CS module 120 in accordance with another embodiment. It should be readily apparent to those of ordinary skill in the art that CS module 120 depicted in FIG. 3 represents a generalized schematic illustration and that other components may be added or existing components may be removed or modified.

As shown in FIG. 3, CS module 120 can comprise a control module 305, an application program interface (“APIT”) 310, a identification (“ID”) interface 315, a search engine 320, and a repository 325. It should be readily obvious to one of ordinary skill in the art that the modules 305-325 can be implemented as software applications (programmed in C, C++, JAVA, PHP, etc.), hardware components (EPROM, application specific integrated circuit, microprocessor, etc.) or combinations thereof.

Control module 305 can be configured to manage and interface with the other modules 310-325 to provide the functionality of the CS module 120 as described above and further described herein below. Additionally, control module 305 can be configured to interface with other modules such as ID module 220 as described above and further described herein below.

API 310 can be configured to generate GUIs, e.g. dialog boxes, web pages, as required by control module 305. For example, API 310 can be configured to generate a configuration data request interface. API 310 can be configured to generate the configuration data request interface to allow the user to enter information identifying the user, details about the user, and details about the software being configured. API 310 can generate the interface based on a request from the software being installed or configured. For example, when the software is installed, the software can automatically send a request to API 310.

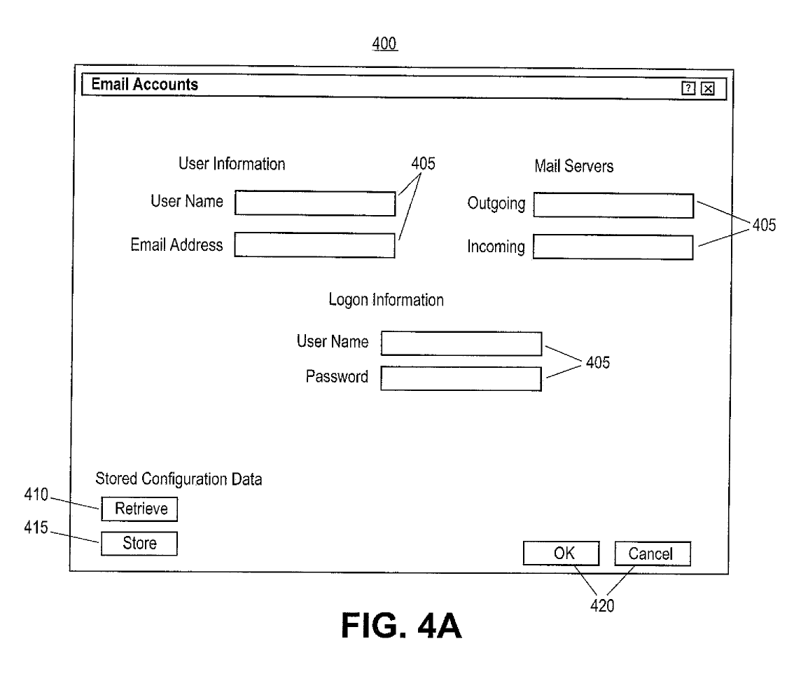

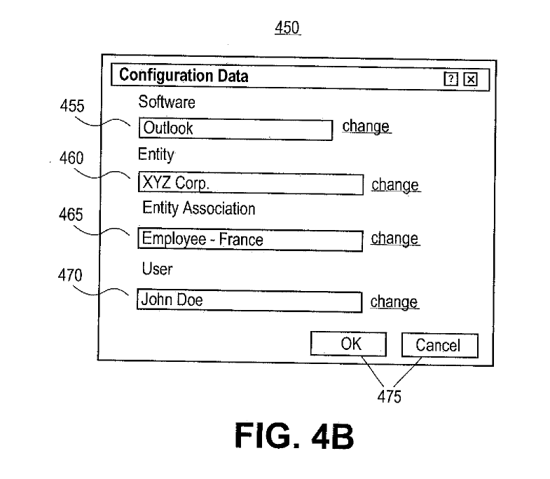

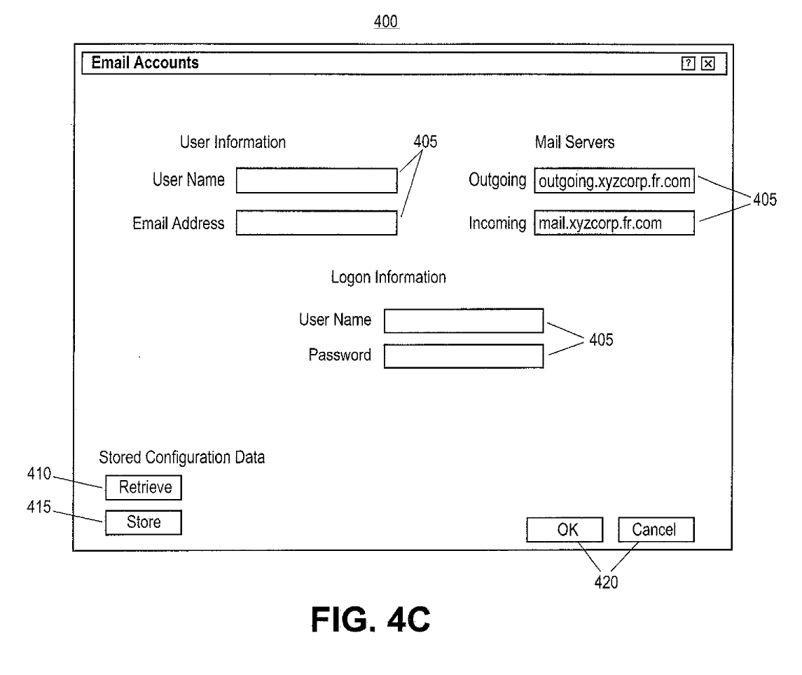

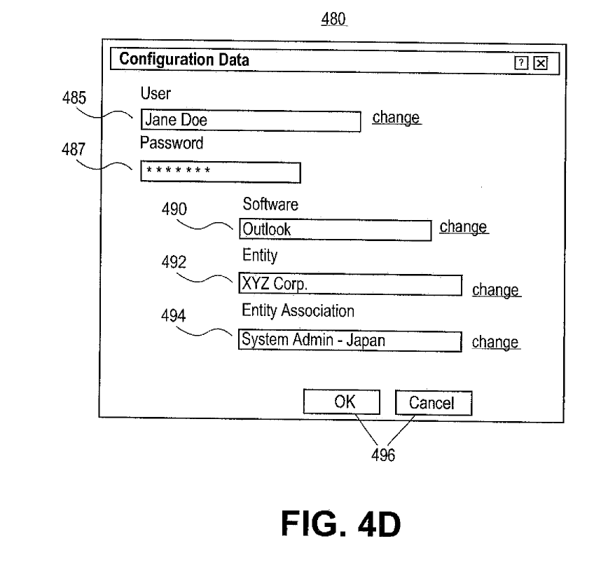

Likewise, the software can include, in a configuration interface, an icon or button that allows the user to send the request to API 310. FIG. 4A is an example of a configuration interface 400 for email software such as Outlook™. As illustrated, interface 400 includes various text fields 405 for entering configuration data for the email software. For example, the configuration data can include information necessary to send and receive email such as user name, email address, outgoing email server, incoming email server, user name, and password.

According to embodiments, interface 400 can include retrieve stored configuration data button 410 and store configuration data button 415. Retrieve stored configuration data button 410 directs the software to send a request to CS module 120 to generate an interface with which the user can request configuration data. FIG. 4 is an example of a request configuration data interface that allows the user to enter identifying information. Store configuration data button 415 allows the user to send configuration data entered in interface 400 to CS module 120 for storage as described below.

FIG. 4B illustrates an exemplary configuration request GUI 450 in accordance with yet another embodiment. It should be readily apparent to those of ordinary skill in the art that GUI 450 depicted in FIG. 4B represents a generalized schematic illustration and that other components may be added or existing components may be removed or modified.

As illustrated, GUI 450 includes a software text field 455, entity text field 460, entity association text field 465, user text field 470, and confirmation buttons 475. Software text field 455 specifies the software being configured. For example, as illustrated, the user can be configuring an email software such as Outlook.

Entity text field 460 allows the user to specify the entity with which the user is related. For example, as illustrated, the user can be associated with an entity called XYZ corporation.

Entity association text field 465 allows the user to specify the user position with the entity. For example, as illustrated, the user can be an employ of a French division of XYZ corporation. User text field 470 allows the user to provide its specific identity. For example, as illustrated, the user specific identity can be “John Doe.”

The information in text fields 455-470 can be entered by the user. Likewise, the information in text fields 455-470 can be automatically populated by CS module 120. For example, when the software sends the request for configuration data, the software can retrieve identifying information from the computing platform on which the software is being configured and transmit the identifying information to CS module 120. API 310 can then populate text fields 455-470 with the transmitted information. When GUI 450 is presented to the user, the user can then alter the information, if the information is incorrect.

Once the user has entered or modified the information in text fields 455-470, the user can transmit the identifying information to CS module 120 by selecting the “OK” button of confirmation buttons 475. The user can also cancel the request by selecting the “Cancel” button of the confirmation buttons 475.

Control module 305 can be configured to receive the user's request for configuration data, for example from GUI 450, via API 310. After reception, control module 305 can determine and verify the identity of the user. For example, control module 305 can verify the identifying information received from the user. Likewise, control module 305 can determine additional identifying information if the user's request did not include all the identifying information.

To achieve this, control module 305 can be coupled to ID interface 315. ID interface 315 can be coupled to ID module 220 of web service portal 115. Control module can utilize ID interface 315 to transmit the identifying information to ID module 220. ID module 220 can complete and verify the identifying information and transmit the results to control module 305 via ID interface 315.

To determine available stored configuration data, control module 305 can also be coupled with search engine 320 and repository 325. Repository 325 can store configuration data for software available on web-service portal 115. Repository 325 can store the configuration data associated with various entities and the software utilized by the entities. Repository 325 can be implemented using a database as known to those skilled in the art.

For example, repository 325 can store configuration data for XYZ Corp. Table 1 illustrates exemplary configuration data stored for XYZ Corp.

TABLE 1
Entity: XYZ
Software: Outlook

| | | Incoming |
|---|---|---|
| Entity Association | Outgoing Mail Server | mail server |
| Employee - United States | outgoing.xyzcorp.com | mail.xyzcorp.com |
| Employee - France | outgoing.xyzcorp.fr.com | mail.xyzcorp.fr.com |
| Employee - Japan | outgoing.xyzcorp.jp.com | mail.xyzcorp.fr.com |

Repository 325 can include similar configuration data tables for different types of software utilized by XYZ Corp. Repository 325 can include similar configuration data tables for different entities. One skilled in the art will realize that the configuration data can be stored in any type of format that is searchable.

To find the stored configuration data, repository 325 can be coupled to search engine 320. Search engine 320 can be configured to allow control module 305 to search for configuration data in repository 325 based on the identifying information received from the software or user. For example, search engine 320 can search repository 325 for stored configuration data for the entity, software type, and entity association. Search engine 320 can be configured to return the search results from a received query to control module 305 for further processing.

Once configuration data has been identified, control module 305 can be configured to transmit the stored configuration data to the software being configured Control module 305 can transmit the configuration data directly to the software being configured. The software can then populate the configuration interface, such as interface 400, with the stored configuration data.

For example, based on the identifying information in GUI 450, control module 305 retrieves the outgoing and incoming mail server for the “employee—France” as stored configuration data. Control module 305 can transmit the configuration data to the email software. FIG. 4C illustrates an example of configuration interface 400 including the transmitted configuration data. As illustrated in FIG. 4C, the email software can populate the appropriate text fields 405 with the transmitted configuration data. The user can then input further configuration data or modify the transmitted configuration data.

Control module 305 can be configured to allow certain users to store configuration data at CS module 120 or modify existing configuration data stored at CS module 120. For example, control module 305 can be configured to receive configuration data directly from the entities acquiring software from web service portal 115. Control module 305 can also receive configuration data from users during configuration of the software.

In order to store configuration data entered during configuration of the software, the user can select an icon or button included in the configuration interface for the software being configured. For example, as illustrated in FIG. 4A, the user can selected store configuration data button 415 in interface 400. In response, the software being configured can transmit a request to CS module 120 to store configuration data.

When the request is received, control module 305 can instruct API 310 to generate a store configuration data GUI and transmit the GUI to the software being configured. The GUI can include text fields for the user to enter information identifying the user and information identifying the configuration data. FIG. 41) illustrates an exemplary GUI 480 for entering information identifying the user and information identifying the configuration data.

As illustrated, in FIG. 4D, GUI 480 can include a user text field 486, password text field 487, software text field 490, entity text field 492, entity association text field 494, and confirmation buttons 496. User text field 486 allows the user to provide its specific identity. For example, as illustrated, the user's specific identity can be “Jane Doe.” Password text field 487 allows the user to provide information, such as a password, to authenticate the identity of the user.

Software text field 490 specifies the software being configured. For example, as illustrated, the user can be configuring an email software such as Outlook.

Entity text field 492 allows the user to specify the entity with which the user is associated. For example, as illustrated, the user can be associated with an entity called XYZ corporation.

Entity association text field 494 allows the user to specify the user position with the entity. For example, as illustrated, the user can be a system administrator of a Japan division of XYZ corporation.

The information in text fields 485-494 can be entered by the user. Likewise, the information in text fields 485-494 can be automatically populated by CS module 120. For example, when the software sends the request to store configuration data, the software can retrieve identifying information from the computing platform on which the software is being configured and transmit the identifying information to CS module 120. API 310 can then populate text fields 485-494 with the transmitted information. When GUI 480 is presented to the user, the user can then alter the information if the information is incorrect.

Once the user has entered or modified the information in text fields 485-494, the user can transmit the identifying information to CS module 120 along with the configuration data by selecting the “OK” button of confirmation buttons 496. The user can also cancel the request by selecting the “Cancel” button of the confirmation buttons 496.

Control module 305 can be configured to receive the user's request to store configuration data, for example from GUI 480, via API 310. After reception, control module 305 can determine and verify the identity of the user. CS module 120 can be configured to allow only certain users to store and modify configuration data. For example, control module 305 can verify the identifying information received from the user such as the user name and password.

Control module 205 can utilize ID interface 315 to transmit the identifying information to ID module 220. ID module 220 can verify the identifying information and transmit the results to control module 305 via ID interface 315.

After verifying the user, control module 205 can store the received configuration data in repository 325. Control module 205 can store the configuration data associated with the identifying information received. For example, control module 205 can store the information in configuration tables as described above.

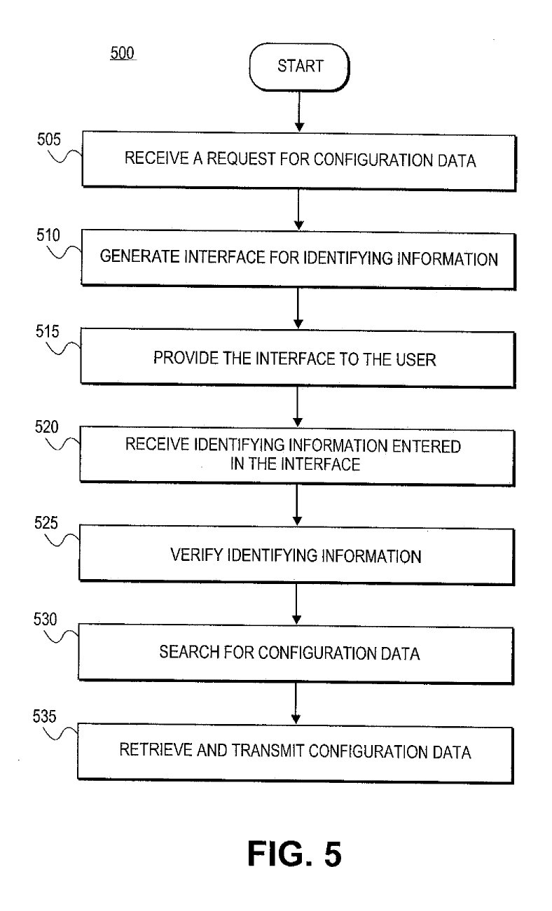

FIG. 5 illustrates a flow diagram 500 for requesting configuration data from CS module 120 in accordance with various embodiments. It should be readily apparent to those of ordinary skill in the art that the flow diagram 500 depicted in FIG. 5 represents a generalized schematic illustration and that other steps may be added or existing steps may be removed or modified.

As shown in FIG. 5, control module 305 can be configured to receive a request for stored configuration data, in step 505. In response, in step 510, control module 305 can instruct API 310 to generate an interface to receive identifying information from the user. More particularly, control module 305 can be configured to generate a GUI, such as GUI 450. In step 515, API 310 can provide the interface to the user.

In step 520, control module 305 can be configured to receive identifying information from the user. Then, in step 525, control module 305 can verify and complete the identifying information of the user. More specifically, control module 305 can transmit the identifying information to ID module 220.

Then, in step 530, control module 305 can search repository 325 to locate stored configuration data. More specifically, control module 305 can perform a search of repository 325 utilizing the received identifying information.

In step 535, control module 305 can retrieve matching stored configuration data and transmit the configuration data to the user.

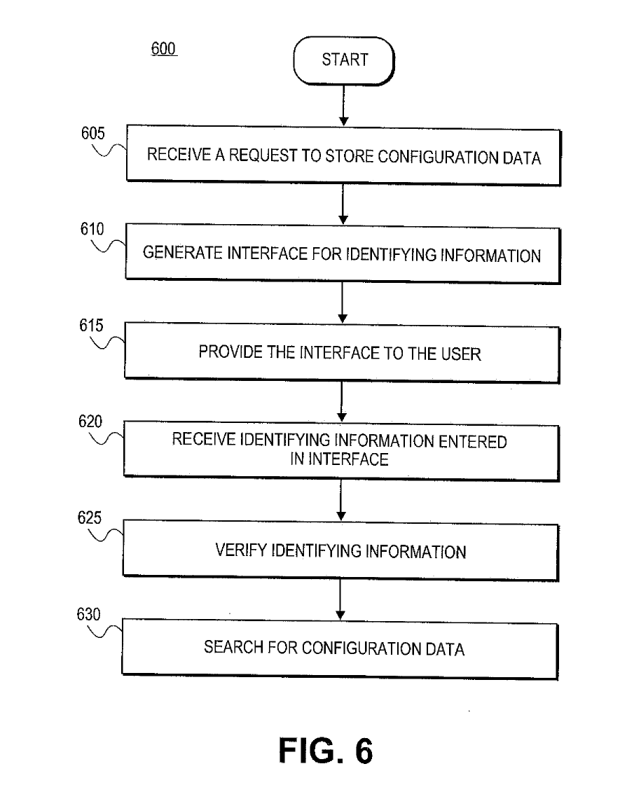

FIG. 6 illustrates a flow diagram 600 for storing configuration data or modifying stored configuration data in accordance with yet another embodiment. It should be readily apparent to those of ordinary skill in the art that the flow diagram 600 depicted in FIG. 6 represents a generalized schematic illustration and that other steps may be added or existing steps may be removed or modified.

As shown in FIG. 6, control module 305 can be configured to receive a request to store configuration data, in step 605. In response, in step 610, control module 305 can instruct API 310 to generate an interface to receive identifying information from the user. More particularly, control module 305 can be configured to generate a GUI, such as GUI 480. In step 615, API 310 can provide the interface to the user.

In step 620, control module 305 can be configured to receive identifying information from the user. Then, in step 625, control module 305 can verify the identifying information of the user. More specifically, control module 305 can transmit the identifying information to ID module 220.

Then, in step 625, control module 305 can store the configuration data in repository 325. More specifically, control module 305 can store the configuration data associated with the identifying information or modify previously stored configuration data associated with the identifying information.

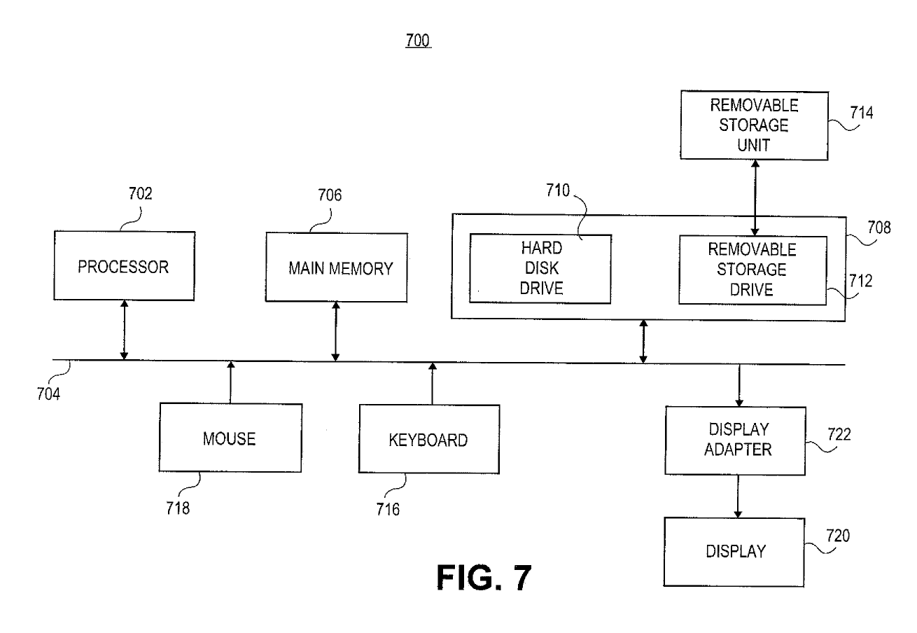

FIG. 7 illustrates an exemplary block diagram of a computing platform 800 where an embodiment may be practiced. The functions of the CS module 120 can be implemented in program code and executed by computing platform 700. CS module 130 may be implemented in computer languages such as PASCAL, C, C++, JAVA, etc.

As shown in FIG. 7, computing platform 700 includes one or more processors, such as processor 702 that provide an execution platform for embodiments of CS module 120. Commands and data from processor 702 are communicated over a communication bus 704. Computing platform 700 also includes a main memory 706, such as a Random Access Memory (RAM), where CS module 120 can be executed during runtime, and a secondary memory 708. Secondary memory 708 includes, for example, a hard disk drive 710 and/or a removable storage drive 712, representing a floppy diskette drive, a magnetic tape drive, a compact disk drive, etc., where a copy of a computer program embodiment for CS module 120 can be stored. Removable storage drive 712 reads from and/or writes to a removable storage unit 714 in a well-known manner. A user interfaces with the CS module 120 with a keyboard 716, a mouse 718, and a display 720. Display adapter 722 interfaces with the communication bus 704 and display 720. Display adapter 722 also receives display data from processor 702 and converts the display data into display commands for display 720.

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

What is claimed is:

1. A method of providing configuration support, the method comprising:
receiving a request for configuration data for software;
generating an interface for entering identifying information, the identifying information comprising information regarding the software and a user configuring the software;
providing the interface to the user;
receiving entered identifying information input into the interface; and
determining stored configuration data associated with the entered identifying information.

2. The method of claim 1, wherein the identifying information comprises an identity of the user, an entity related to the user, an association of the user to the entity, and an identity of the software.

3. The method of claim 1, further comprising:
transmitting the determined configuration data to the user.

4. The method of claim 1, wherein determining stored configuration data comprises searching a repository, containing the stored configuration data, for the stored configuration data associated with identifying information matching the entered identifying information and retrieving the matching stored configuration data.

5. The method of claim 1, wherein receiving a request for configuration data for software comprises receiving a portion of the identifying information and wherein generating the interface comprises populating the interface with the portion of the identifying information.

6. The method of claim 1, further comprising verifying the entered identifying information.

7. A method of providing configuration support, comprising:
receiving a request to store configuration data for software;
generating an interface for entering identifying information, the identifying information comprising information regarding the software and a user configuring the software;
providing the interface to the user;
receiving entered identifying information input into the interface and entered configuration data for the software;
verifying the identifying information; and
storing the entered configuration data associated with the received identifying information.

8. The method of claim 7, wherein the identifying information comprises an identity of the user, an entity related to the user, an association of the user to the entity, and an identity of the software.

9. An apparatus for providing configuration support, the apparatus comprising:
a program interface adapted to receive requests for configuration support for software, the program interface configured to generate an interface for entering identifying information, the identifying information comprising information regarding the software and a user configuring the software, wherein the request comprises requests to retrieve and to store configuration data;
a control module coupled to the program interface, the control module configured to determine configuration data matching the identifying information and to store configuration data associated with the identifying information; and
a repository coupled to the control module, the repository configured to store the configuration data associated with the identifying information.

10. The apparatus of claim 9, wherein the control module is further configured to receive entered identifying information input into the interface and to determine stored configuration data associated with the entered identifying information.

11. The apparatus of claim 10, wherein the control module is further configured to transmit the determined configuration data to a user.

12. The apparatus of claim 10, further comprising:
an identification interface coupled to the control module, the identification interface is configured to transmit the entered identifying information for verification.

13. The apparatus of claim 10, wherein the repository is further configured to store the configuration data associated with an entity related to the user, an association of the user to the entity, and an identity of the software.

14. A system for developing providing support, the system comprising:
a network configured to provide a communication channel for a plurality of users; and
a web service portal coupled to the network and configured to provide products and services to the plurality of users, wherein the web-service portal further comprises:
a program interface adapted to receive requests for configuration support for software, the program interface configured to generate an interface for entering identifying information, the identifying information comprising information regarding the software and a user configuring the software, wherein the request comprises requests to retrieve and to store configuration data;
a control module coupled to the program interface, the control module configured to determine configuration data matching the identifying information and to store configuration data associated with the identifying information; and
a repository coupled to the control module, the repository configured to store the configuration data associated with the identifying information.

15. The system of claim 14, wherein the control module is further configured to receive entered identifying information input into the interface; and to determine stored configuration data associated with the entered identifying information.

16. The system of claim 15, wherein the control module is further configured to transmit the determined configuration data to a first user of the plurality of users.

17. The system of claim 15, the web service portal further comprising:
an identification module coupled to the control module, wherein the identification module is configured to verify the entered identifying information.

18. The system of claim 15, wherein the repository is further configured to store the configuration data associated with an entity related to the first user, an association of the first user to the entity, and an identity of the software.
